(19) United States
(12) Patent Application Publication
(10) Pub. No.: US 2019/0058525 A1
(43) Pub. Date: Feb. 21, 2019

(54) Cellular Fiber Monitoring Module

(71) Applicant: Terrance O'Brien Woodbridge, Cary, NC (US)

(72) Inventor: Terrance O'Brien Woodbridge, Cary, NC (US)

(73) Assignee: TransHawk Systems LLC, Arlington, VA (US)

(21) Appl. No.: 14/663,859

(22) Filed: Mar. 20, 2015

Related U.S. Application Data
(63) Continuation-in-part of application No. 14/157,775, filed on Jan. 17, 2014, now abandoned.

(51) Int. Cl. H04B 10/2575; H04B 10/077

(52) U.S. Cl. CPC H04B 10/25753; H04B 10/0771

(57) ABSTRACT

A cellular fiber monitoring module (CFMM) for a remote cellular tower site is implemented by providing monitoring for fiber connections between mobile carrier's broadcast ground equipment and its corresponding antenna equipment located on the cellular tower. Each monitoring module includes a fiber optic monitor pass though module which integrates the necessary monitoring data for each base transceiver station (BTS) equipment including, fiber port pass/fail status, peak to peak level measurement, optical degradation, BTS fault status, etc. The CFMM can be used as a stand-alone device or integrated into an on-site monitoring system.

### REFERENCE TO PRIORITY DOCUMENTS

This Application is a continuation-in-part of, and claims priority under 35 U.S.C § 120 to co-pending U.S. patent application Ser. No. 14/157,775 filed Jan. 17, 2014, which is incorporated by reference for all purposes.

### FIELD OF THE INVENTION

The present invention relates to the method of monitoring fiber connections at a cellular tower site. More particularly, the connection between the carrier's base transceiver station (BTS) and the remote radio head (RRH).

### BACKGROUND OF THE INVENTION

The fiber connection between a mobile carriers base transceiver station (BTS) and the remote radio head (RRH) are a vital part of telecommunications networks. In most situations the RRH is located on the tower within close proximity to the antenna. Installing the RRH closer to the antenna helps reduce cable loss, maximize power efficiency, and minimize interference. In most cases the connection between the BTS and the RRH is fiber. This connection is not remotely monitored for signal integrity and connection quality. A fault in this connection would have a negative impact on the transmitting and receiving of data and mobile calls.

### SUMMARY OF THE INVENTION

Cellular Fiber Monitoring Module (CFMM) invention has several implementations. A primary embodiment of the invention is implemented as a part of a full cellular tower site monitoring system. Additionally, an alternate embodiment of the invention may be implemented as a stand-alone fiber monitoring device with a cellular modem.

The primary embodiment of the invention is for monitoring the fiber connection between the mobile carrier's base transceiver station (BTS) equipment located at ground level and its corresponding remote radio head (RRH) located on the cell tower. In the primary embodiment of the invention the cellular fiber monitoring module (CFMM) reports any faults associated with this connection to an on-site monitoring system. This on-site monitoring system is situated at the site and collects, stores, analyzes and reports information around the clock to the network operations center (NOC). The integration of the CFMM gives the ability to report any faults or problems with the fiber connection. The monitored functions of the CFMM include, but are not limited to:
Fiber breakage
Peak to peak level
Optical degradation
Carrier's BTS fault

Another embodiment includes a stand-alone function of the cellular fiber monitoring module (CFMM). As a single device it can monitor all the same functions without being connected to an on-site monitoring system. In this configuration of the CFMM can report all faults remotely though the use of a cellular modem. Examples of monitored functions include, but are not limited to:
Fiber breakage
Peak to peak level
Optical degradation
Carrier's BTS fault
Modem test report

Each cellular fiber monitoring module (CFMM) is a stand-alone component designed to be located at the carrier's base transceiver station (BTS) equipment. It is a passive device that is connected in-line between the carrier's base transceiver station (BTS) equipment and its corresponding remote radio head (RRH). It is a pass through devices allowing the fiber signal to pass through without be effecting. It is connected to the carrier's equipment through the use of fiber jumpers. The fiber optic signal is analyzed as it passes through the CFMM. It is designed with the ability to be connect directly to an onsite monitoring system utilizing several forms of connection including but not limited to
CANOpen
RS232
RS485
4-20 mA
Dry form C

Each cellular fiber monitoring module (CFMM) has a unique media access control address (MAC) that identifies itself, its monitoring points associated with its location and equipment being monitored. This gives the ability to have multiple CFMM's located at a single cell site. Allowing the monitoring on multiple carriers and multiple devices.

### BRIEF DESCRIPTION OF THE DRAWINGS

FIG. 1 illustrates a first embodiment of the cellular fiber monitoring module (CFMM) and its key components.

FIG. 2 illustrates a functional relationship between the cellular fiber monitoring module (CFMM) connected to a full cellular tower site monitoring system and its connections to the carrier components in the field.

FIG. 3 illustrates a functional relationship between the cellular fiber monitoring module (CFMM) as a standalone component connected to a cellular modem and its connection to the carrier components in the field.

### DETAILED DESCRIPTION AND BEST MODE OF IMPLEMENTATION

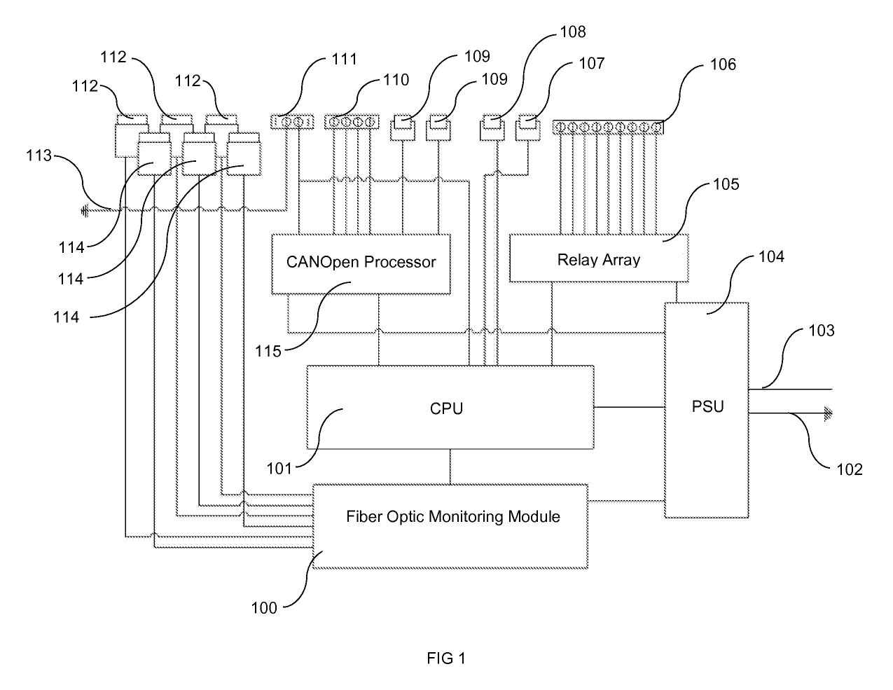

Referring now to FIG. 1, a first embodiment of the cellular fiber monitoring module (CFMM) is shown. The CFMM is comprised of five main components shown. The first component being a fiber optic monitoring pass through module 100 with multiple taps. This component is used to monitor the fiber optic signal for faults as it passes through the device. This component takes the incoming fiber 112 from the carrier's base transceiver station (BTS) equipment and passes it through the fiber optic monitoring pass through module 100 and sends the optical signal back out the fiber optic output 114 to the remote radio head (RRH). Giving it the ability to monitor breakage, faults and uplink integrity of the fiber between the two devices.

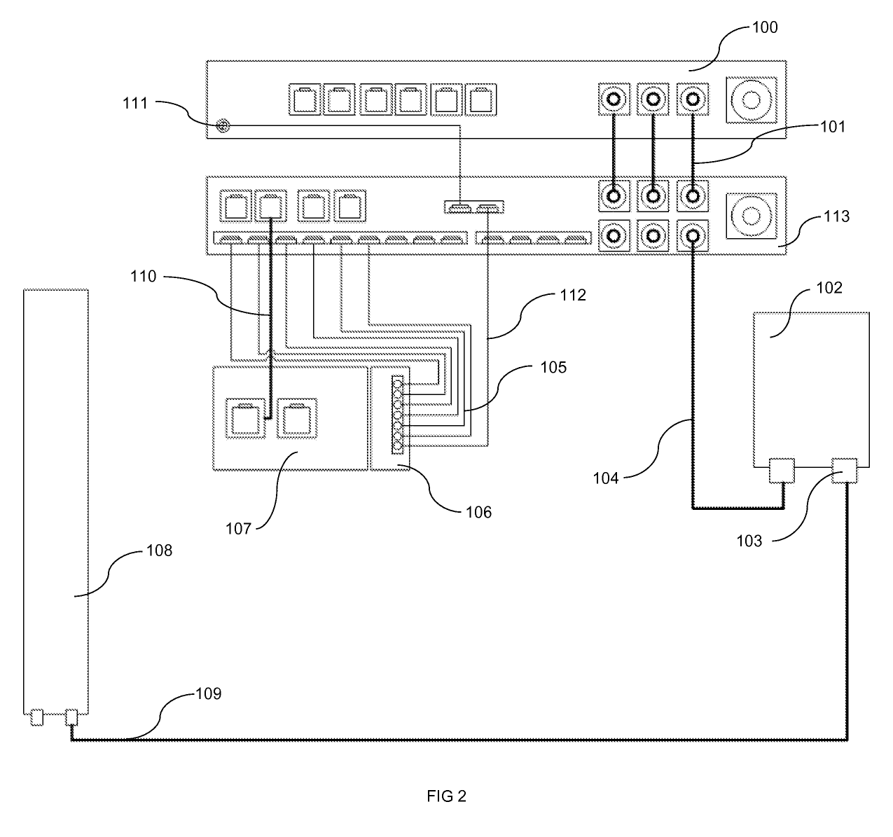

Referring now to FIG. 2, the cellular fiber monitoring module (CFMM) 113, in a primary embodiment, is shown connected to an onsite monitoring system 107. In general, the connection to the onsite monitoring system 107 is through a CANOpen protocol connection 110.

Also referring to FIG. 2, the cellular fiber monitoring module (CFMM) 113 is connected between the mobile carriers base transceiver station (BTS) equipment 100 and the remote radio head RRH 102 using fiber. The BTS transmits and receives through the fiber connected 101 to the CFMM 113. The monitored connection continues on from the CFMM 113 through the use of fiber 104 to the RRH 102, where it broadcast its signal to its antenna 108 through coaxial cable 109.

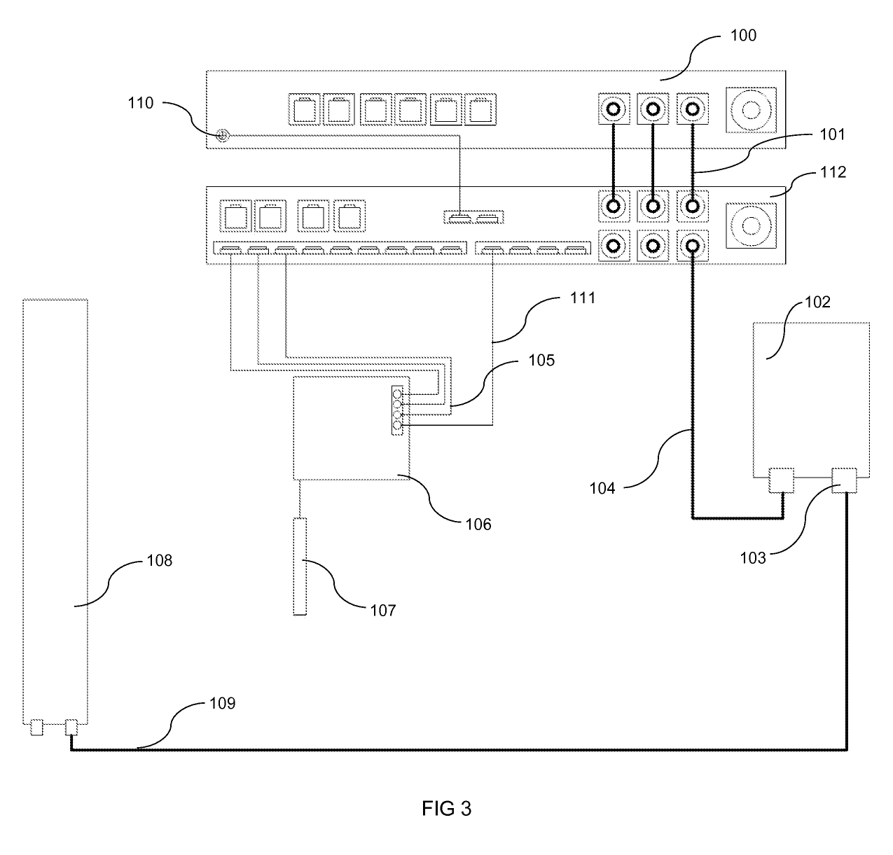

Referring now to FIG. 3, the cellular fiber monitoring module (CFMM) 113, is shown connected in a standalone state. In this state the CFMM can still report status of the fiber connect between the mobile carriers base transceiver station (BTS) equipment 100 and the remote radio head RRH 102. This is done through the use of a cellular modem 106. This connection to the cellular modem is a hard wire connection 105. This connection is based on faults from the CFMM.

1. A system comprised of a cellular fiber monitoring module (CFMM) connected between a mobile carrier's base transceiver station (BTS) equipment located at ground level within a cellular tower site and the corresponding remote radio head (RRH) located on the same tower. Said fiber monitoring module is configured to monitor the fiber for signal for faults as it passing through the device.

2. The system as recited in claim 1, wherein pass/fail status of the fiber data connection are monitored.

3. The system as recited in claim 1, wherein peak to peak levels with the fiber connection are monitored.

4. The system as recited in claim 1, wherein fiber degradation is monitored.

5. The system as recited in claim 1, wherein carrier's base transceiver station fault output is monitored.
